(19) United States
(12) Patent Application Publication
(10) Pub. No.: US 2014/0355017 A1
(43) Pub. Date: Dec. 4, 2014

(54) COLOR ADJUSTING SYSTEM, COLOR ADJUSTING METHOD, AND NON-TRANSITORY COMPUTER READABLE RECORDING MEDIUM STORED WITH COLOR ADJUSTING PROGRAM

(71) Applicant: KONICA MINOLTA INC., Chiyoda-ku (JP)

(72) Inventor: Tsuyoshi SUGITA, Hachioji-shi (JP)

(21) Appl. No.: 14/294,658

(22) Filed: Jun. 3, 2014

(30) Foreign Application Priority Data
Jun. 4, 2013 (JP) 2013-118071

(51) Int. Cl. G06K 15/02

(52) U.S. Cl. CPC G06K 15/1878
USPC 358/1.9

(57) ABSTRACT

A color adjusting system (1) of the present invention applies separate pieces of correcting data to a single color chart and a mixed color chart, respectively, and prints both charts on one sheet. Therefore, when this print result is observed, it is possible to confirm whether a single color is appropriately corrected and also to determine whether a mixed color needs to be corrected. When no color adjustment is necessary for the mixed color, it is not necessary to prepare a mixed color chart afterwards. Accordingly, unnecessary printing or color adjustment is not performed, which enables to perform an efficient color adjustment.

### CROSS-REFERENCE TO RELATED APPLICATION

This application is based on Japanese Patent Application No. 2013-118071 filed on Jun. 4, 2013, the contents of which are incorporated herein by reference.

### BACKGROUND

### Technical Field

In an image forming apparatus such as a printer and a copier, due to changes in use environment and temporal degradation of components and the like, an image is occasionally printed out with output image quality different from intended image quality. Therefore, a color adjustment is appropriately performed so as to print out as intended.

In a density correction or a color (gray) balance correction that is a type of color adjustment, a chart including a number of color patches is printed to perform a correction based on a color measurement result obtained visually or using a color measurement device.

For example, Japanese Laid-open Patent Publication No. 10-322562 has disclosed a color adjustment performed by executing the following processes of (1) to (4):

(1) print a single color chart for performing a density correction for single colors of cyan (C), magenta (M), yellow (Y), and black (K) and then prepare single color correcting data where a density correction rule is defined,

(2) print, on one sheet, the previously printed single color chart and a mixed color chart for performing a correction (color balance correction) for a mixed color obtained by mixing single colors at a predetermined ratio using the prepared single color correcting data,

(3) prepare mixed color correcting data where a mixed color correction rule is defined, based on a print result of the process (2), and

(4) print the previously printed mixed color chart, using the prepared mixed color correcting data.

Execution of the process (2) makes it possible for a user to confirm whether a single color image is appropriately printed out. Further, execution of the processes (3) and (4) makes it possible to confirm whether a mixed color image is also appropriately printed out.

However, Japanese Laid-open Patent Publication No. 10-322562 merely discloses that in the process (2), both of a single color chart and a mixed color chart are printed using the same single color correcting data. Therefore, even upon observing the mixed color chart printed in the process (2), it is not possible for a user to determine whether a color adjustment is necessary for the mixed color. In other words, it becomes possible to determine whether a color adjustment is necessary for the mixed color only after executing the processes (3) and (4).

Therefore, there is a problem that the processes (3) and (4) are executed even when it is not necessary to perform a color adjustment for the mixed color.

### SUMMARY

In view of the above circumstances, the present invention has been developed and aims to provide a color adjusting system, a color adjusting method, and a non-transitory computer readable recording medium stored with a color adjusting program, that are capable of efficiently determining whether it is necessary to perform a color adjustment for a mixed color.

To achieve at least one of the abovementioned objects, a color adjusting system reflecting one aspect of the present invention is a color adjusting system for performing a color adjustment by printing a single color chart where a single color used for an image forming material for printing is expressed using a plurality of single color patches having different densities and a mixed color chart where a mixed color obtained by composing the plurality of different single colors at a predetermined ratio is expressed using a plurality of mixed color patches having different densities, the color adjusting system comprising: a storage unit storing mixed color data for performing color and density adjustments for said mixed color; a first printing unit printing said single color chart; a single color data preparing unit preparing single color data for performing a density adjustment for said single color based on a color measurement result of said single color patches in said printed single color chart; and a second printing unit printing said single color chart and said mixed color chart on one sheet by applying, to said single color chart, single color data prepared by said single color data preparing unit and by applying, to said mixed color chart, said single color data and said existing mixed color data.

Further, it is preferable that the color adjusting system described above further comprises: an accuracy calculating unit calculating an adjustment accuracy in color and density based on a color measurement result of said mixed color patches in said mixed color chart printed by said second printing unit; and a display unit displaying said adjustment accuracy calculated by said accuracy calculating unit.

Further, it is preferable that the color adjusting system described above further comprises: a third printing unit printing said mixed color chart by applying, to said mixed color chart, said single color data prepared by said single color data preparing unit; a mixed color data preparing unit preparing mixed color data for performing color and density adjustments for said mixed color based on a color measurement result of said mixed color patches in said mixed color chart printed by said third printing unit; and an updating unit updating mixed color data stored in said storage unit, using mixed color data prepared by said mixed color data preparing unit.

Further, in the color adjusting system described above, it is preferable that separate attribute information is allocated to said single color chart and said mixed color chart, respectively, and said second printing unit determines whether said single color data is applied or both of said single color data and said mixed color data are applied according to said attribute information.

Further, in the color adjusting system described above, it is preferable that said second printing unit prints one type of said single color chart and one type of said mixed color chart respectively selected from a plurality of types of said single color charts and a plurality of types of said mixed color charts, that are previously prepared, when printing said single color chart and said mixed color chart on one sheet.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a hardware configuration of a color adjusting system;

FIG. 2 is a block diagram illustrating a functional configuration of the color adjusting system;

FIG. 3 is a view illustrating a print result of a single color chart;

FIG. 4 is a view illustrating a print result of a mixed color chart;

FIG. 5 is a view illustrating a print result of a single color chart and a mixed color chart;

FIG. 6 is a diagram specifically illustrating color conversion processing;

FIG. 7 is a flowchart illustrating steps of color adjustment processing;

FIG. 8 is a view illustrating a display example of a basic screen;

FIG. 9 is a flowchart illustrating steps of single color adjustment processing;

FIG. 10 is a flowchart illustrating steps of confirmation processing;

FIG. 11 is a view illustrating a display example of a result screen;

FIG. 12 is a diagram illustrating an example of threshold values used for determining whether to perform a color adjustment;

FIG. 13 is a flowchart illustrating steps of mixed color adjustment processing; and

FIG. 14 is a view illustrating a modification example of a single color chart and a mixed color chart.

### DETAILED DESCRIPTION

The embodiments of this invention will be described below with reference to the accompanying drawings. The same sign is assigned to the same element in the description of the drawings, and overlapping description will be omitted. Further, dimensional ratios in the drawings are exaggerated for descriptive convenience and may differ from actual ones in some cases.

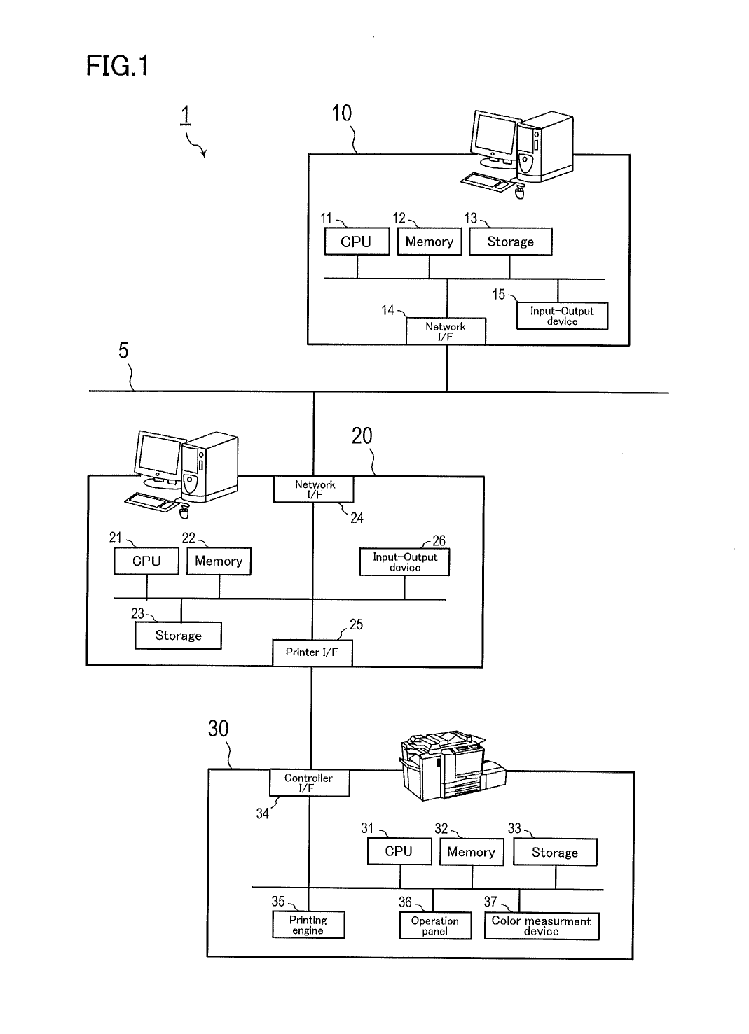

FIG. 1 is a diagram illustrating one example of a hardware configuration of a color adjusting system 1 according to the present embodiment. With reference to FIG. 1, a schematic configuration, specifically, the hardware configuration of the color adjusting system 1 will be described below.

### <Color Adjusting System 1>

As illustrated in FIG. 1, the color adjusting system 1 includes a client device 10, a printer controller 20, and a printer 30.

The client device 10 and the printer controller 20 are connected for intercommunication via a computer network (hereinafter, simply referred to as “network 5”). The network 5 is configured from a Local Area Network (LAN) which connects computers and network apparatuses in conformity with a standard, such as the Ethernet (registered trademark), a token ring, or a Fiber Distributed Data Interface (FDDI), a Wide Area Network (WAN) which connects LANs through dedicated lines, and the like.

Further, the printer controller 20 may be connected to the printer 30 through, for example, a bus for a dedicated interface such as an IEEE1394 serial bus or a Universal Serial Bus (USB). In addition, the printer controller 20 and the printer 30 may be connected via the network 5. In addition, the printer controller 20 may be integrated with the printer 30 by storing the printer controller 20 in the housing of the printer 30.

Meanwhile, the type and the number of devices connected to the network 5 are not limited to the example illustrated in FIG. 1.

### <Client Device 10 (Hardware Configuration)>

Next, a hardware configuration of the client device 10 will be described below.

The client device 10 is a general-purpose computer that is a device generating a print job. As the client device 10, for example, a desktop PC (personal computer) as illustrated in FIG. 1 is usable and also a mobile terminal such as a tablet terminal, a smartphone, and a mobile phone is usable.

Further, the client device 10 can instruct, via a remote operation, RIP processing (rasterizing processing) executed by the printer controller 20, specifically a color adjustment (including a density correction and a color balance correction) of subject data to be printed, included in a print job.

The subject data to be printed may be, for example, PDL (Page Description Language) data described using a PDL that can be interpreted by the printer controller 20. Further, the print job includes basic setting information on the number of copies, sheet size, single-side/double-side printing, monochrome/color printing, and the like, besides subject data to be printed.

The client device 10 as described above includes, as illustrated in FIG. 1, a CPU (Central Processing Unit) 11, a memory 12, a storage 13, a network interface (I/F) 14, and an input-output (I/O) device 15. These units are connected to each other via a bus in order to exchange signals.

The CPU 11 is a control circuit including a multi-core processor and the like for controlling the abovementioned respective units and executing various types of operational processes in accordance with a program. Each function of the client device 10 is realized in such a way that the CPU 11 executes a program corresponding to each function.

The memory 12 is a main memory device which temporarily stores a program or data as a work area and which can be accessed at high speed. For example, a Dynamic Random Access Memory (DRAM), a Synchronous Dynamic Random Access Memory (SDRAM), a Static Random Access Memory (SRAM), or the like is used as the memory 12.

The storage 13 is a high-capacity auxiliary storage device which stores various types of programs, including an operating system, and various types of data. For example, a flash memory, a solid-state drive, a hard disk, a Read Only Memory (ROM), or the like is used as the storage 13.

The network I/F 14 is an interface for communicating with other devices (e.g., the printer controller 20) via the network 5 and a standard, such as Ethernet (registered trademark), Wi-Fi, FDDI, and Token Ring, is used.

The input-output device 15 is, for example, an input device such as a keyboard and a mouse, and an output device such as a liquid crystal display.

### <Printer Controller 20 (Hardware Configuration)>

Next, a hardware configuration of the printer controller 20 will be described below.

The printer controller 20 is a device executing RIP processing for subject data to be printed, included in a print job transferred from the client device 10. The RIP processing generates image data (raster data) printable on the printer 30. The printer controller 20 transfers the generated image data to the printer 30 to print the transferred data.

Further, it is possible for the printer controller 20 to perform a color adjustment for subject data to be printed based on an instruction from the client device 10.

The printer controller 20 is a general-purpose computer, and, for example, a desktop PC (personal computer) as illustrated in FIG. 1 is usable.

The printer controller 20 as described above includes, as illustrated in FIG. 1, a CPU 21, a memory 22, a storage 23, a network interface (I/F) 24, a printer interface (I/F) 25, and an input-output (I/O) device 26. These units are connected to each other via a bus in order to exchange signals.

The CPU 21 is a control circuit including a multi-core processor and the like for controlling the abovementioned respective units and executing various types of operational processes in accordance with a program. Each function of the printer controller 20 is realized in such a way that the CPU 21 executes a program corresponding to each function.

The memory 22 is a main memory device which temporarily stores a program or data as a work area and which can be accessed at high speed. For example, a DRAM, a SDRAM, a SRAM, or the like is used as the memory 22.

The storage 23 is a high-capacity auxiliary storage device which stores various types of programs, including an operating system, and various types of data. For example, a flash memory, a solid-state drive, a hard disk, a Read Only Memory (ROM), or the like is used as the storage 23.

The network I/F 24 is an interface for communicating with other devices (e.g., the client device 10) via the network 5 and a standard, such as Ethernet (registered trademark), Wi-Fi, FDDI, and Token Ring, is used.

The printer I/F 25 is an interface (VIF: Video Interface) for communicating with the printer 30, and sequentially transfers, to the printer 30, image data (raster data) having been subjected to RIP. Instead of VIF, it is possible to appropriately employ a serial interface such as RS-232 (Recommended Standard 232) C, IEEE (Institute of Electrical and Electronics Engineers) 1394, and USB (Universal Serial Bus), a parallel interface such as IEEE 1284, or an interface based on a proprietary standard.

The input-output device 26 is, for example, an input device such as a keyboard and a mouse, and an output device such as a liquid crystal display.

### <Printer 30 (Hardware Configuration)>

Next, a hardware configuration of the printer 30 will be described below.

The printer 30 includes at least a printing function and is used to print image data (raster data) transmitted from the printer controller 20. Needless to say, the printer 30 may be an MFP (Multi-Function Peripheral) further including a copy function, a scan function, a facsimile function, and the like in addition to the printing function.

Further, it is possible for the printer 30 to measure a color of a print result and to transmit the color measurement result to the printer controller 20 as necessary.

The printer 30 as described above includes, as illustrated in FIG. 1, a CPU 31, a memory 32, a storage 33, a controller interface (I/F) 34, a printing engine 35, an operation panel 36, and a color measurement device 37. These units are connected to each other via a bus in order to exchange signals.

The CPU 31 is a control circuit including a microprocessor and the like for controlling the abovementioned respective units and executing various types of operational processes in accordance with a program. Each function of the printer 30 is realized in such a way that the CPU 31 executes a program corresponding to each function.

The memory 32 is a main memory device which temporarily stores a program or data as a work area and which can be accessed at high speed. For example, a DRAM, a SDRAM, a SRAM, or the like is used as the memory 32.

The storage 33 is a high-capacity auxiliary storage device which stores various types of programs, including an operating system, and various types of data. For example, a flash memory, a solid-state drive, a hard disk, a Read Only Memory (ROM), or the like is used as the storage 33.

The controller I/F 34 is an interface (VIF: Video Interface) for communicating with the printer controller 20. Needless to say, instead of VIF, it is possible to appropriately employ a serial interface such as RS-232C, IEEE 1394, and USB, a parallel interface such as IEEE 1284, or an interface based on a proprietary standard.

The printing engine 35 prints image data (raster data) output from the printer controller 20. The printing engine 35, for example, includes a cartridge filled with toner, a photoreceptor drum, a laser beam irradiation mechanism, a sheet feed conveyance mechanism, a sheet feed and discharge mechanism, and the like, and is a laser-type unit for performing printing by transferring the toner on a print medium such as a print sheet.

The operation panel 36 includes a touch panel, and is configured so as to display a progress status of a print job and an occurrence status of an error, and so as to be able to perform various types of operations (inputs).

The color measurement device 37 measures a color of a print result (printed matter) of image data (raster data) transmitted from the printer controller 20 and provides the color measurement result to the client device 10. The color measurement device 37 performs a color measurement, for example, using an inline sensor disposed in the middle of a conveyance path where printed matter is conveyed to a sheet discharge tray. The inline sensor allows the color of the entire width of the printed matter to be measured. Further, the color measurement is performed in such a manner that light is emitted from a light source (lamp) to uniformly illuminate the printed matter and reflective light is focused onto an optical receiver via an optical receiving lens.

The client device 10, the printer controller 20, and the printer 30 including the hardware configurations as described above respectively include the following functional configurations.

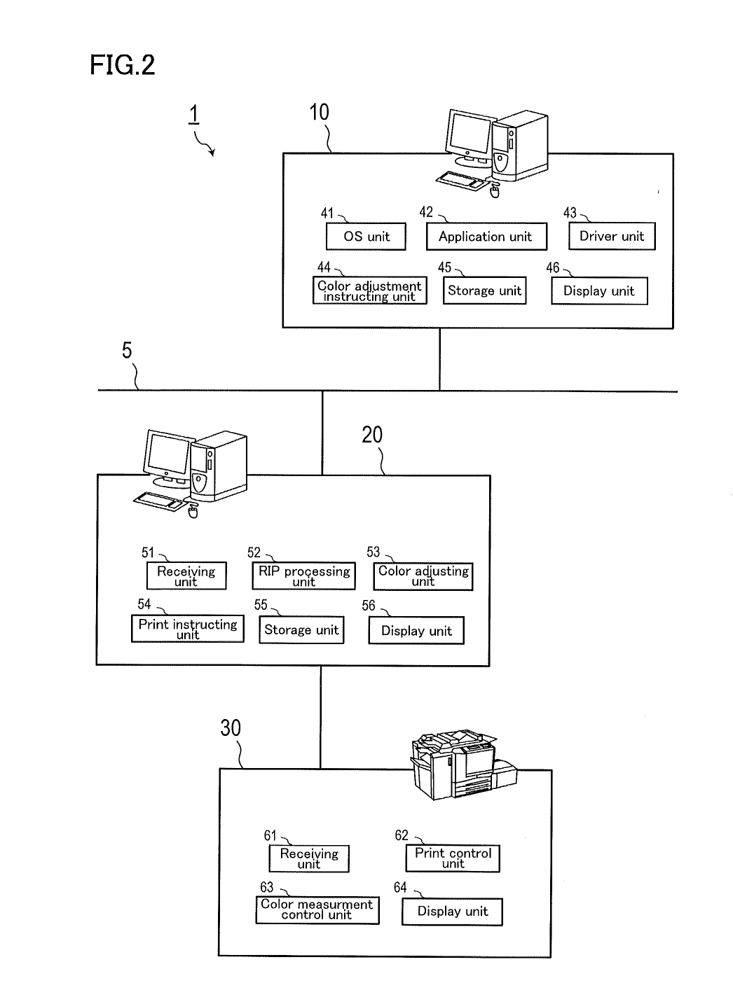

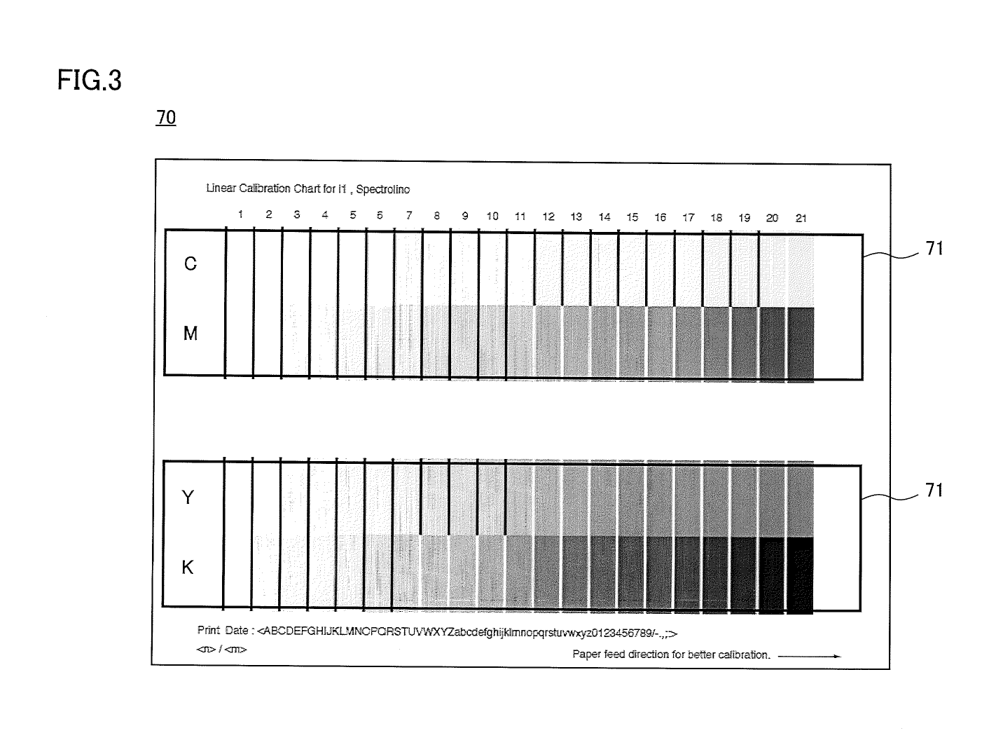

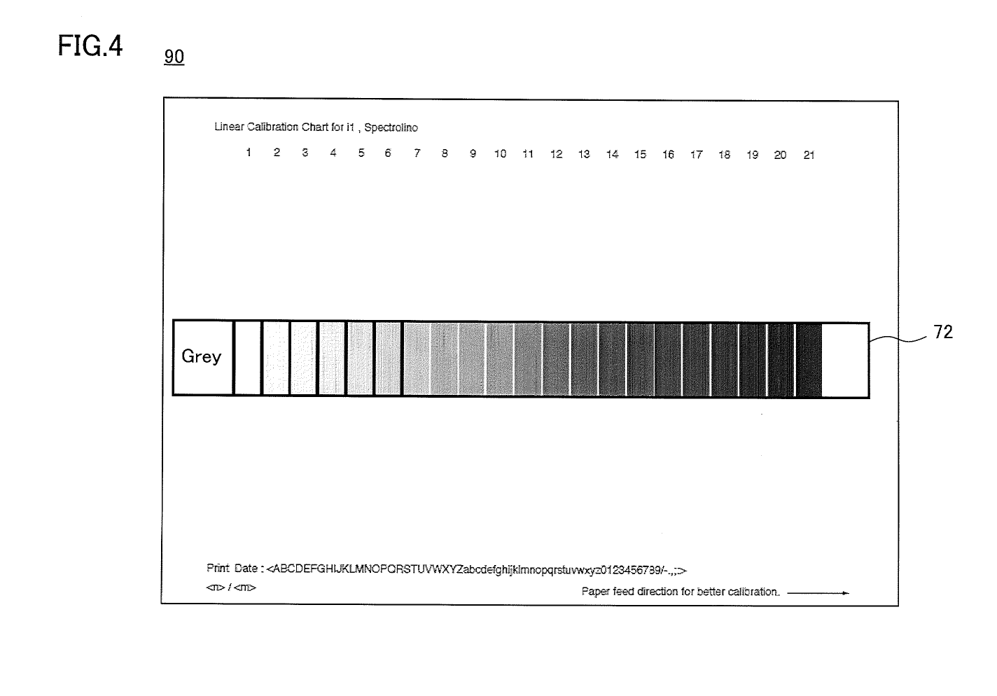

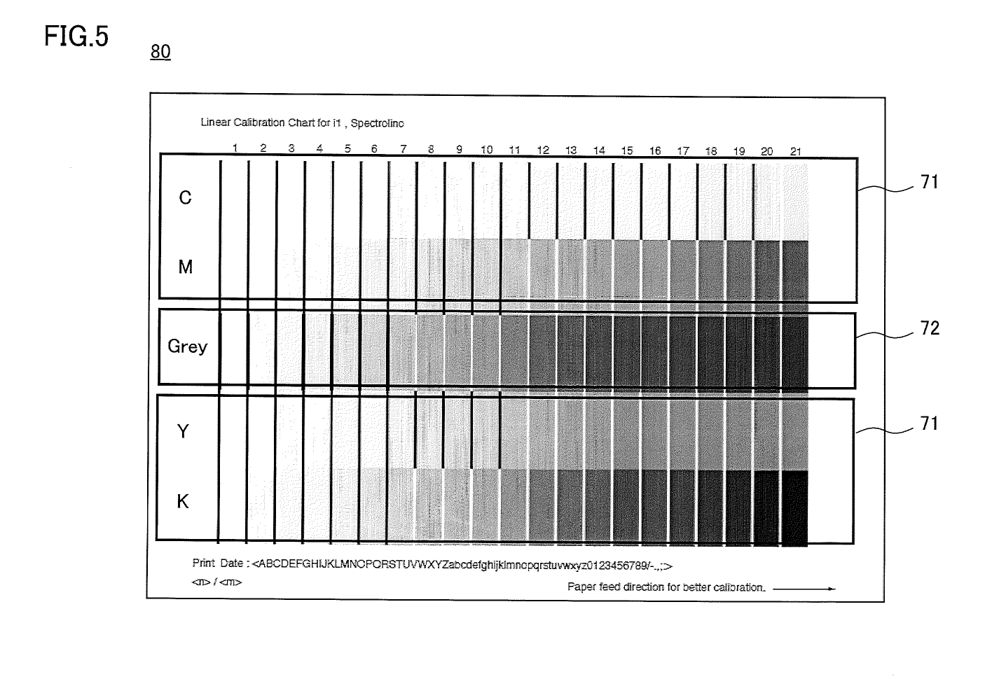

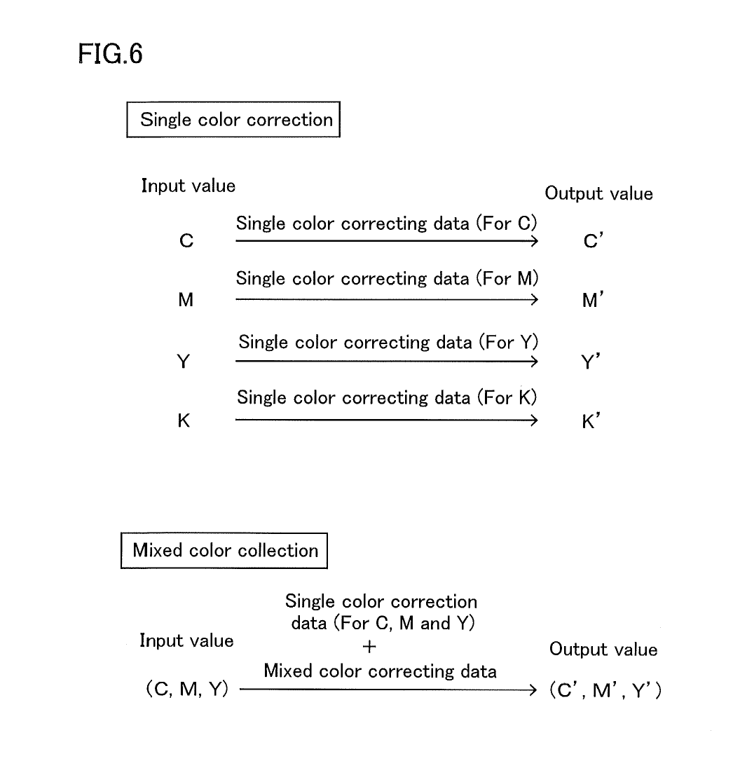

FIG. 2 is a diagram illustrating one example of a functional configuration of the color adjusting system 1 according to the present embodiment. FIG. 3 is a view illustrating an example of a print result when a single color chart, to be described later, is printed on one sheet. FIG. 4 is a view illustrating an example of a print result when a mixed color chart, to be described later, is printed on one sheet. FIG. 5 is a view illustrating a print result when both a single color chart and a mixed color chart are printed on one sheet. FIG. 6 is a diagram specifically illustrating color conversion processing, to be described later.

### <Client Device 10 (Functional Configuration)>

First, a functional configuration of the client device 10 will be described below.

As illustrated in FIG. 2, the client device 10 includes, as the functional configuration, an OS (Operating System) unit 41, an application unit 42, a driver unit 43, a color adjustment instructing unit 44, a storage unit 45, and a display unit 46.

The OS unit 41 is a so-called basic computer software for providing system management of the client device 10 and a basic user operation environment.

The application unit 42 operates in accordance with a common program for preparing document data, installed on the client device 10. The document data is prepared, for example, in accordance with a program for preparing a document, a program for drawing graphics, and a program for editing an image.

The driver unit 43 is a software for causing the client device 10 to function as a client of the printer controller 20. Specifically, the driver unit 43 reads document data, converts the data into subject data to be printed (e.g., PDL data) that can be interpreted by the printer controller 20, and transmits the converted data to the printer controller 20 as a print job.

The color adjustment instructing unit 44 provides GUI (Graphical User Interface) that can issue an instruction on RIP processing, specifically, a color adjustment executed by the printer controller 20. The color adjustment of the present embodiment includes a density correction for performing a density adjustment for a color used for an image forming material for printing (ink, toner, and the like), the color being a single color such as cyan (C), magenta (M), yellow (Y), and black (K). The color adjustment further includes a color balance correction for performing color and density adjustments for a mixed color obtained by composing a plurality of different colors at a predetermined ratio. Then, the color adjustment instructing unit 44 outputs an instruction content input using GUI to the printer controller 20.

The storage unit 45 stores a single color chart where a plurality of patches having different densities for each single color (hereinafter, referred to as “single color patch”) are arranged, and a mixed color chart where a plurality of patches having different densities for a mixed color of at least one color (hereinafter, referred to as “mixed color patch”) are arranged.

As the example illustrated in FIG. 3, a single color chart 71 includes 21×4 single color patches with different densities arranged for each single color of cyan (C), magenta (M), yellow (Y), and black (K). Further, as the example illustrated in FIG. 4, a mixed color chart 72 includes 21 mixed color patches with different densities arranged for a gray color (a color obtained, for example, by composing single colors of cyan (C), magenta (M), and yellow (Y) at a ratio of 1:1:1). Further, while detailed description will be made later, as the example illustrated in FIG. 5, the single color chart 71 and the mixed color chart 72 are occasionally printed on one sheet together.

Further, the display unit 46 of FIG. 2 displays GUI provided by the color adjustment instructing unit 44.

The OS unit 41, the application unit 42, the driver unit 43, and the color adjustment instructing unit 44 are realized when the CPU 11 reads an OS and a program installed in the storage 13 to the memory 42 and executes the OS and the program. Further, the storage unit 45 is realized by the storage 13 and the memory 12, and the display unit 46 is realized by an output device such as a display.

### <Printer Controller 20 (Functional Configuration)>

Next, a functional configuration of the printer controller 20 will be described below.

As illustrated in FIG. 2, the printer controller 20 includes, as the functional configuration, a receiving unit 51, a RIP processing unit 52, a color adjusting unit 53, a print instructing unit 54, a storage unit 55, and a display unit 56.

The receiving unit 51 receives a print job transmitted from the client device 10 via the network 5.

The RIP processing unit 52 executes RIP processing for subject data to be printed, included in the received print job to generate image data (raster data) in a bitmap format. The RIP processing executed by the RIP processing unit 52 of the present embodiment includes language analysis processing, color conversion processing, screen processing, and the like.

In the language analysis processing, the RIP processing unit 52 interprets subject data to be printed (e.g., PDL data), included in a print job, to convert the interpreted data into intermediate data referred to as DisplayList. The intermediate data is stored on the memory 22 or the like. Further, the intermediate data may be generated with respect to each object or by each band.

Further, in the color conversion processing, the RIP processing unit 52 converts colors of the intermediate data generated by the language analysis processing (e.g., C, M, Y, and K) into colors to be output (e.g., C′, M′, Y′, and K′).

In the color conversion processing, as illustrated in FIG. 6, the RIP processing unit 52 performs at least one of a density correction for performing a density adjustment for a single color (also referred to as “single color correction”) and a color balance correction for performing color and density adjustments for a mixed color (also referred to as “mixed color correction”).

In the single color correction, as illustrated in the upper figure of FIG. 6, density is adjusted with respect to each single color. Specifically, the RIP processing unit 52 applies single color correcting data to density values of the respective single colors included in the intermediate data generated by the language analysis processing (input values: C, M, Y, and K) to convert the values into new density values (output values: C′, M′, Y′, and K′). For the single color correcting data, for example, a table (a one-dimensional look-up table or the like) of associating a density value of a single color to be input (input value) with a density value of a single color to be output (output value) is used.

In the mixed color correction, as illustrated in the lower figure of FIG. 6, color and density adjustments are performed for a specific mixed color obtained by composing at least two single colors at a predetermined ratio. In other words, the RIP processing unit 52 converts ratios and densities of single colors which constitute each of the mixed colors included in the intermediate data. Specifically, the RIP processing unit 52 applies single color correcting data and mixed color correcting data to each of density values of at least two single colors constituting a specific mixed color included in the intermediate data (input values: C, M, Y, and K) to convert the values into density values to be output (output values: C′, M′, Y′, and K′). For the mixed color correcting data, for example, a table (multi-dimensional look-up table or the like) of associating a combination of respective density values with respect to single colors constituting a mixed color to be input (input value) with a combination of respective density values with respect to single colors constituting a mixed color to be output (output value) is used.

Further, in the screen processing, the RIP processing unit 52 binarizes color-converted intermediate data. This screen processing generates raster data for one page to be developed on a frame memory of the memory 22 or the like.

The color adjusting unit 53 performs a color adjustment (also referred to as “calibration”) with respect to printing on the printer 30 in accordance with an instruction from the client device 10. For example, the color adjusting unit 53 performs an adjustment (including correction and preparation) of the single color correcting data and the mixed color correcting data, described above, based on a color measurement result when the printer 30 prints the single color chart 71 and the mixed color chart 72.

The print instructing unit 54 outputs an instruction for causing the printer 30 to print image data (raster data) generated by the RIP processing unit 52. Specifically, the print instructing unit 54 generates a print command based on basic setting information included in a received print job and transmits the command to the printer 30 together with image data.

The storage unit 55 stores single color correcting data, mixed color correcting data, and the like used for color conversion processing.

The display unit 56 displays a screen necessary for a work in the printer controller 20. Further, the display unit 56 may display the same screen as a screen displayed by the display unit 46 of the client device 10.

The receiving unit 51 is realized by the network I/F 24. Further, the RIP processing unit 52, the color adjusting unit 53, and the print instructing unit 54 are realized when the CPU 21 reads a program installed in the storage 23 to the memory 22 and executes the program, or by the printer I/F 25. Needless to say, with no limit thereto, the abovementioned units may be realized by hardware such as an ASIC (Application Specific Integrated Circuit) and the like. Further, the storage unit 55 is realized by the storage 23 and the memory 22, and the display unit 56 is realized by an output device such as a display and the like.

### <Printer 30 (Functional Configuration)>

Next, a functional configuration of the printer 30 will be described below.

As illustrated in FIG. 2, the printer 30 includes, as the functional configuration, a receiving unit 61, a print control unit 62, a color measurement control unit 63, and a display unit 64.

The receiving unit 61 receives a print command and image data (raster data) transmitted from the printer controller 20.

The print control unit 62 prints the image data (raster data) transmitted from the printer controller 20. Specifically, the print control unit 62 controls the printing engine 35 and a printing head (not illustrated) to execute printing processing in accordance with the print command received together with the image data.

The color measurement control unit 63 controls a color measurement. Specifically, the color measurement control unit 63 controls the color measurement device 37 and the like so as to cause a color of a print result (printed matter) generated by printing performed by the printing engine 35 to be measured.

The display unit 64 displays a progress status of printing and an occurrence status of an error.

The receiving unit 61 is realized by the controller I/F 34. The print control unit 62 and the color measurement control unit 63 are realized when the CPU 31 reads a program installed in the storage 33 to the memory 32 and executes the program. Needless to say, with no limit thereto, the abovementioned units may be realized by hardware such as an ASIC and the like. Further, the display unit 64 is realized by the operation panel 36 such as a touch panel and the like.

### <Operations of Color Adjusting System 1>

Next, characteristic operations of the color adjusting system 1 will be described below.

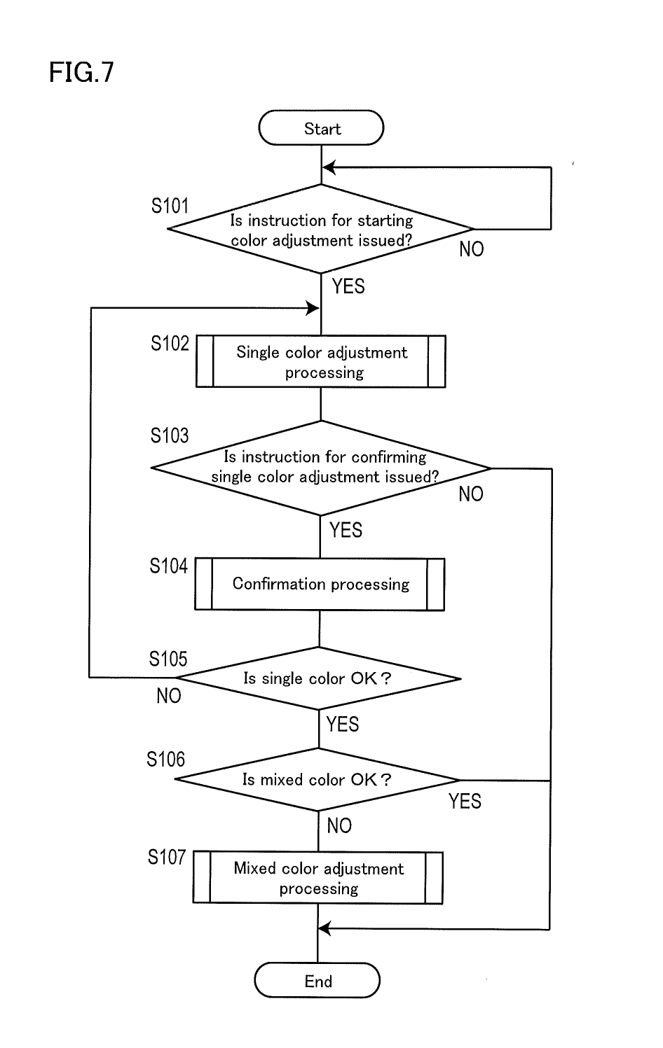

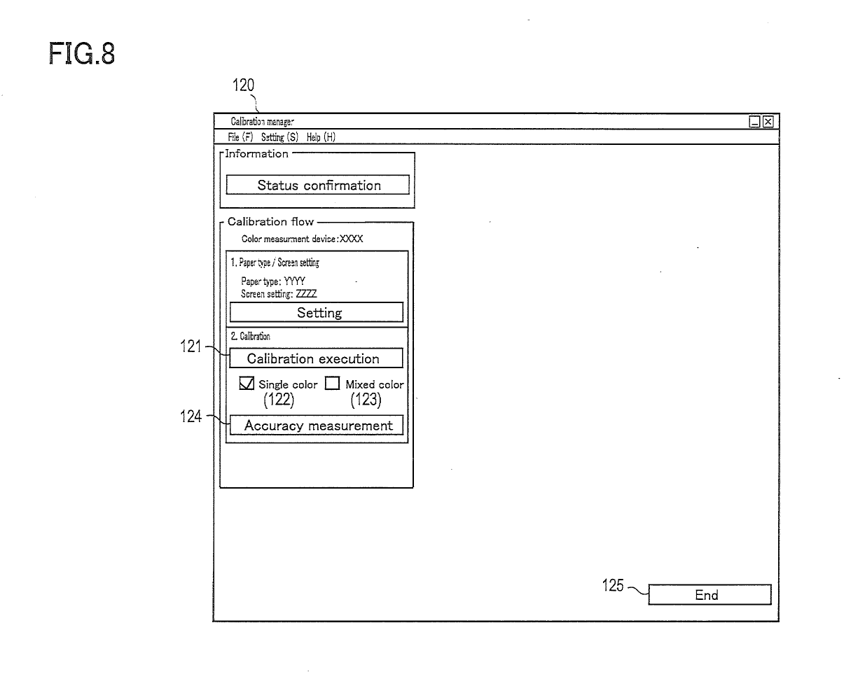

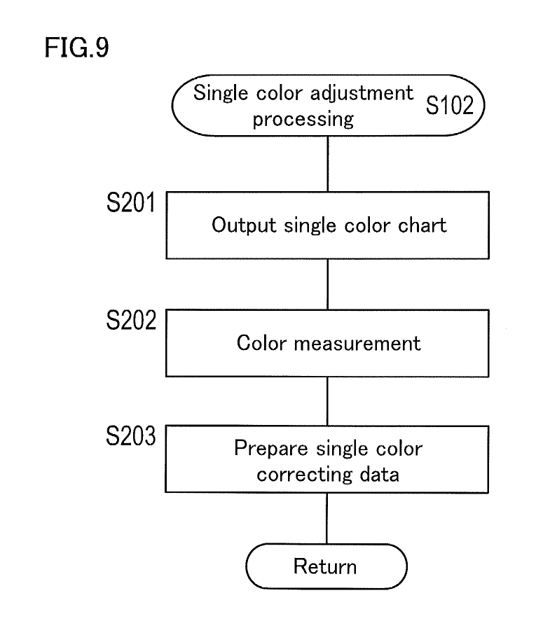

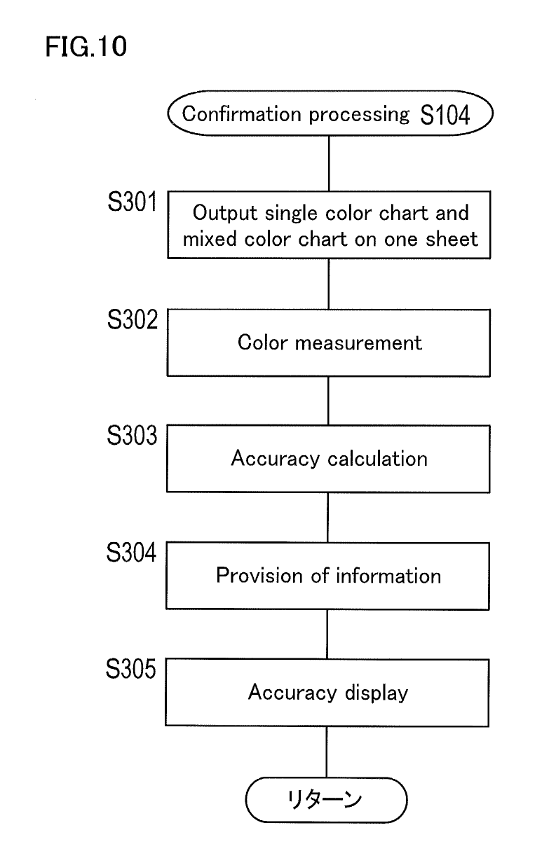

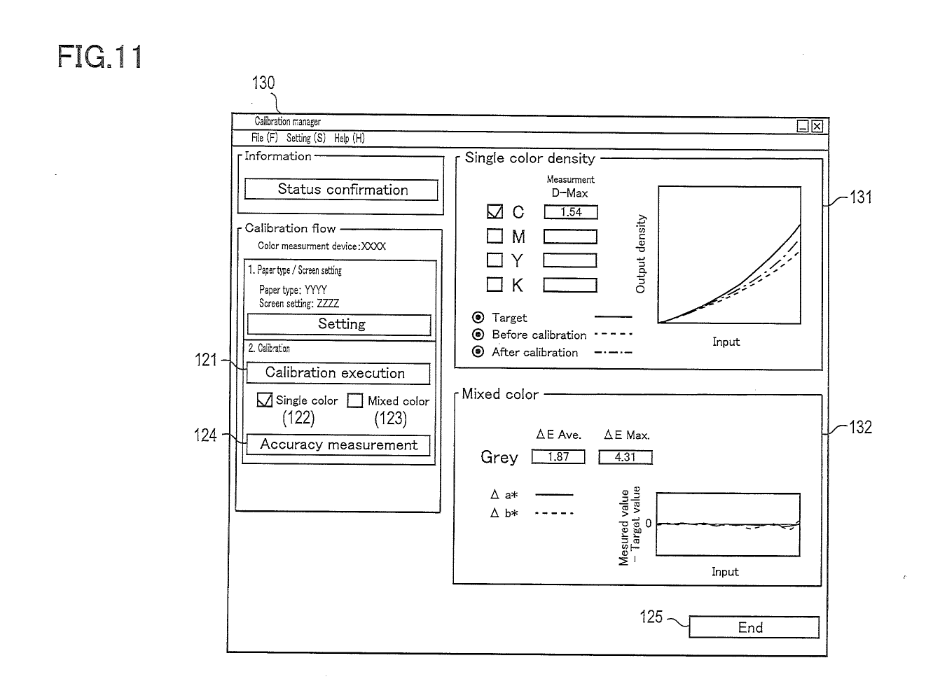

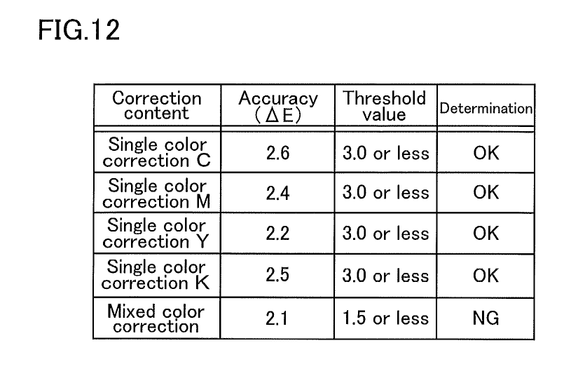

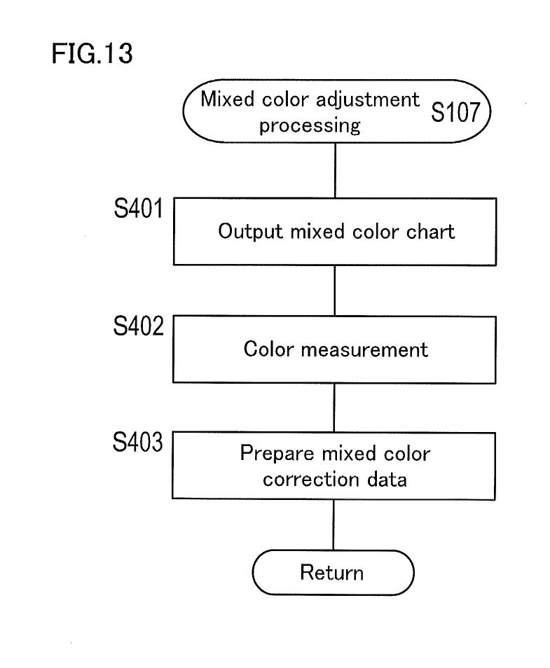

FIG. 7 is a flowchart illustrating steps of color adjustment processing executed in the color adjusting system 1. FIG. 8 is a view illustrating a display example of a basic screen for allowing a user to make an instruction on a color adjustment. FIG. 9 is a flowchart illustrating steps of single color adjustment processing executed in step S102 of the color adjustment processing. FIG. 10 is a flowchart illustrating steps of confirmation processing executed in step S104 of the color adjustment processing. FIG. 11 is a view illustrating a display example of a result screen of a color adjustment. FIG. 12 is a diagram illustrating an example of threshold values used for determining whether to perform a color adjustment. FIG. 13 is a flowchart illustrating steps of mixed color adjustment processing executed in step S107 of the color adjustment processing.

With reference to FIGS. 7 to 13, steps of the color adjustment processing (including the single color adjustment processing S102, the confirmation processing S104, and the mixed color adjustment processing S107) will be described below.

### <Color Adjustment Processing>

First, color adjustment processing (FIG. 7) will be described.

For example, in the case of printing document data prepared by the application unit 42, the client device 10 functions as the driver unit 43 and starts color adjustment processing illustrated in FIG. 7, when receiving an instruction for starting print setting. Further, even in the case of printing no document data, color adjustment processing may be started by operating an icon for starting the color adjustment processing. An instruction for starting print setting and an icon operation are made, for example, by a user operating an input device (the input-output device 15) such as a keyboard and a mouse.

After this flowchart starts, the client device 10 functions as the display unit 46 so as to perform a color adjustment and displays a basic screen 120 for a color adjustment on an output device (the input-output device 15) such as a display.

The basic screen 120 includes, as illustrated in FIG. 8, for example, at least a calibration execution button 121 for issuing an instruction for starting a color adjustment, a single color check box 122 for printing the single color chart 71 upon execution of the color adjustment, a mixed color check box 123 for printing the mixed color chart 72 upon execution of the color adjustment, an accuracy measurement button 124 for issuing an instruction for performing accuracy measurement of the color adjustment, and an end button 125 for issuing an instruction for ending the color adjustment.

While the basic screen 120 is displayed, the client device 10 determines whether or not an instruction for starting the color adjustment is issued (step S101). Specifically, the client device 10 functions as the color adjustment instructing unit 44 and determines whether or not the calibration execution button 121 on the basic screen 120 is operated.

When the calibration button 121 is not operated (step S101: No), the client device 10 determines that no instruction for starting the color adjustment is issued and waits until the calibration execution button 121 is operated. Although not illustrated in the figure, when the calibration execution button 121 is operated while the mixed color check box 123 is checked, the processing of steps S102 to S106 may be omitted to advance the process to S107.

On the other hand, when the calibration execution button 121 is operated while the single color check box 122 is checked (step S101: Yes), the client device 10 determines that an instruction for starting monochrome adjustment processing for adjusting a single color is issued, and advances the process to the single color adjustment processing (step S102) illustrated in FIG. 9.

### <Single Color Adjustment Processing S102>

When the single color adjustment processing starts, the client device 10 transmits an instruction for outputting the single color chart 71 to the printer controller 20 (step S201). Specifically, the client device 10 functions as the driver unit 43, reads the single color chart 71 from the storage unit 45, and converts the chart into PDL data that can be interpreted by the printer controller 20. Then, the converted data is transmitted to the printer controller 20 as a print job.

At this time, the printer controller 20 functions as the receiving unit 51 to receive the print job transmitted from the client device 10, and then executes processing necessary to print the single color chart 71. Specifically, the printer controller 20 functions as the RIP processing unit 52 and generates raster data in a bitmap format by executing RIP processing for the single color chart 71 included in the received print job. As described above, the RIP processing includes the language analysis processing, the color conversion processing, the screen processing, and the like. In the color conversion processing in this case, the latest single color correcting data stored in the storage unit 55 is applied to perform a single color correction.

After completion of the RIP processing, the printer controller 20 functions as the print instructing unit 54 and transmits the raster data generated by the RIP processing to the printer 30. Then, the printer 30 functions as the receiving unit 61 to receive the raster data, and then controls, as the print control unit 62, the printing engine 35 to print out the single color chart 71 as the example illustrated in FIG. 3 on one sheet.

Further, after transmitting an instruction for outputting the single color chart 71 in step S201, the client device 10 also transmits an instruction for measuring a color of the print result (printed matter) (step S202). Specifically, the client device 10 functions as the driver unit 43 and transmits, to the printer controller 20, data for issuing an instruction for color measurement.

At this time, the printer controller functions as the receiving unit 51 to receive the instruction for color measurement from the client device 10, and then functions as the print instructing unit 54 to transmit, to the printer 30, a command for measuring a color of the print result (printed matter) of the single color chart 71. Then, the printer 30 functions as the receiving unit 61 to receive the command for the color measurement, and then controls, as the color measurement control unit 63, the color measurement device 37 to measure a color of the single color chart 71. After completion of the color measurement, the printer 30 transmits a color measurement result of the single color chart 71 to the printer controller 20.

The printer controller receives the color measurement result of the single color chart 71 and then performs a color adjustment for the single color based on the received color measurement result (step S203). Specifically, the printer controller 20 functions as the color adjusting unit 53 and corrects single color correcting data so that a printed density of each of the single color patches included in the single color chart 71 comes closer to a target value. Hereinafter, the color adjustment preformed in step S203 is referred to as “single color calibration.”

When the single color calibration in S203 ends, the printer controller 20 terminates the single color adjustment processing S102.

With the color adjusting system 1 executing the single color adjustment processing S102 described above, it is possible to perform a color adjustment for a single color.

Then, when the single color adjustment processing S102 is terminated, the client device 10 advances the process to step S103 as illustrated in FIG. 7 and determines whether or not an instruction for confirming a result of the single color adjustment processing S102 is issued (step S103). Specifically, the client device 10 functions as the color adjustment instructing unit 44 and determines whether or not the accuracy measurement button 124 on the basic screen 120 is operated.

When the accuracy measurement button 124 is not operated (step S103: No), the client device 10 determines that no instruction for confirming the result of the single color adjustment processing S102 is issued and terminates this flowchart.

On the other hand, when the accuracy measurement button 124 is operated (step S103: Yes), the client device 10 determines that an instruction for starting confirmation processing for confirming the result of the single color adjustment processing S102 is issued, and advances the process to the confirmation processing (step S104) illustrated in FIG. 10.

### <Confirmation Processing S104>

When the confirmation processing starts, the client device 10 transmits an instruction for outputting the single color chart 71 and the mixed color chart 72 to the printer controller 20 (step S301). Specifically, the client device 10 functions as the driver unit 43, reads the single color chart 71 and the mixed color chart 72 from the storage unit 45, and converts the charts into PDL data that can be interpreted by the printer controller 20. Then, the converted data is transmitted to the printer controller 20 as a print job.

At this time, when functioning as the receiving unit 51 to receive the print job transmitted from the client device 10, the printer controller 20 executes processing necessary to print the single color chart 71 and the mixed color chart 72. Specifically, the printer controller 20 functions as the RIP processing unit 52, executes RIP processing for the single color chart 71 and the mixed color chart 72 included in the received print job, and generates raster data in a bitmap format. As described above, the RIP processing includes the language analysis processing, the color conversion processing, the screen processing, and the like. In the color conversion processing in this case, the latest single color correcting data prepared in the preceding single color adjustment processing S102 is applied to the single color chart 71 for a single color correction. Further, the single color correcting data applied to the single color chart 71 and mixed color correcting data used in the past, if present, are applied to the mixed color chart 72 for a mixed color correction. When no mixed color correcting data is present, the mixed color correction is not performed, and then only the single color correcting data is applied so as to compose single colors in accordance with a predetermined ratio to reproduce colors of the mixed color patches.

After completion of the RIP processing, the printer controller 20 functions as the print instructing unit 54 and transmits the raster data generated by the RIP processing to the printer 30. Then, when functioning as the receiving unit 61 to receive the raster data, the printer 30 controls, as the print control unit 62, the printing engine 35 and outputs the single color chart 71 and the mixed color chart 72 as the example illustrated in FIG. 5 by printing the charts on one sheet.

Further, after transmitting an instruction for outputting the single color chart 71 and the mixed color chart 72 in step S301, the client device 10 also transmits an instruction for measuring a color of the print result (printed matter) (step S302). Specifically, the client device 10 functions as the driver unit 43 and transmits, to the printer controller 20, data for issuing an instruction for color measurement.

At this time, the printer controller 20 functions as the receiving unit 51 to receive the instruction for color measurement from the client device 10. Thereafter, the printer controller 20 functions as the print instructing unit 54 and transmits, to the printer 30, a command for measuring a color of the print result (printed matter) of the single color chart 71 and the mixed color chart 72. When functioning as the receiving unit 61 to receive the command for the color measurement, the printer 30 controls, as the color measurement control unit 63, the color measurement device 37 and measures a color of the single color chart 71 and the mixed color chart 72. After completion of the color measurement, the printer 30 transmits, to the printer controller 20, a color measurement result of the single color chart 71 and the mixed color chart 72.

When receiving the color measurement result of the single color chart 71 and the mixed color chart 72, the printer controller 20 calculates an adjustment accuracy of the mixed color chart 72 to which the single color correcting data prepared in the single color adjustment processing S102 is applied, based on the received color measurement result (step S303).

In the present embodiment, as indicators expressing an adjustment accuracy of the mixed color chart 72, an average adjustment accuracy (ΔEave) and a maximum adjustment accuracy (ΔEmax) respectively determined by the following Expressions 1 and 2 are used.

ΔEab={(a1−a2)2+(b1−b2)2}(½) (Expression 1)

ΔΔave=□(ΔEab)/N (Expression 2)

where “ΔEab” represents an adjustment accuracy of each mixed color patch constituting the mixed color chart 72, “a1” and “b1” represent target values (a value and b value of an Lab value) of each mixed color patch, and “a2” and “b2” represent color measurement values (a value and b value of an Lab value) of each mixed color patch. Each of “a1” and “b1” is a value previously stored in the storage unit 55 and each of “a2” and “b2” is a color measurement result obtained in step S302. Further, “ΔEave” represents an average value (average adjustment accuracy) of ΔEab's of all the mixed color patches constituting the mixed color chart 72, and “N” represents the number of all the mixed color patches constituting the mixed color chart 72.

Further, the printer controller 20 determines a maximum adjustment accuracy ΔEmax that is a maximum value of the adjustment accuracies ΔEab's of the respective mixed color patches.

After completion of the calculation in step S303, the printer controller 20 provides necessary information to the client device 10 so that a user can determine whether to further perform a color adjustment for the single color or the mixed color (step S304). Specifically, the printer controller 20 transmits, to the client device 10, the color measurement result (before calibration) of the single color chart 71 obtained by the color measurement in step S202, the color measurement result (after calibration) of the single color chart 71 obtained by the color measurement in step S302, and the adjustment accuracy (ΔEave, ΔEmax) of the mixed color chart 72 calculated in step S303.

When receiving various types of information provided by the printer controller 20, the client device 10 displays information necessary for a user to determine whether to further perform a color adjustment for the single color or the mixed color (step S305). Specifically, the client device 10 functions as the display unit 46 to display a result screen 130 of the color adjustment on an output device (the input-output device 15) such as a display.

The result screen 130 includes, as illustrated in FIG. 11, at least a first result area 131 for displaying an adjustment result of a density of a single color and a second result area 132 for displaying an adjustment accuracy of a mixed color, for example.

In the first result area 131, a first graph of graphing relationship between a density value (input density) of each single color patch constituting the single color chart 71 and a density value (output density) of each single color patch upon printing by applying, to the single color chart 71, single color correcting data before being subjected to the single color calibration S203, is displayed. In addition, a second graph of graphing relationship between a density value (input density) of each single color patch constituting the single color chart 71 and a density value (output density) of each single color patch upon printing by applying, to the single color chart 71, single color correcting data after being subjected to the single color calibration S203, is displayed in an overlapping manner. Further, a third graph of graphing relationship to be targeted by the input density and the output density may be displayed in an overlapping manner.

For preparation of the first graph, the color measurement result of the single color chart 71 obtained by the color measurement in step S202 is used. For preparation of the second graph, the color measurement result of the single color chart 71 obtained by the color measurement in step S302 is used. For preparation of the third graph, a target value previously prepared in the storage device 45 or the like is used.

Further, the second result area 132 displays the adjustment accuracy (ΔEave, ΔEmax) of the mixed color chart 72 calculated in step S303. Still further, fourth and fifth graphs of graphing values of “a1-a2” and “b1-b2” respectively with respect to each mixed color patch constituting the mixed color chart 72 may be displayed.

After displaying the result screen 130 in S305, the client device 10 terminates the confirmation processing S104.

When the color adjusting system 1 executes the abovementioned confirmation processing S104, in step S301, the single color chart 71 to which the adjusted single color correcting data is applied, and the mixed color chart 72 to which the adjusted single color correcting data and the mixed color correcting data are applied, are printed on one sheet.

When observing the single color chart 71 thus printed, a user can confirm whether the color adjustment of the single color is appropriately performed in the single color adjustment processing S102. At this time, when a further color adjustment of the single color is needed, the user can additionally execute the single color adjustment processing S102.

Further, when observing the printed mixed color chart 72, the user can determine whether to perform a color adjustment also for the mixed color. The reason is that even when the single color chart 71 is printed appropriately, there is a problem in a color (gray) balance obtained by composing a plurality of single colors when the mixed color chart 72 is not printed appropriately.

Further, in step S305, an adjustment result (131) of a density of the single color and an adjustment accuracy (132) of the mixed color are displayed. Therefore, the user not only can visually observe a print result of the single color chart 71 and the mixed color chart 72 but also objectively determine whether to perform a color adjustment for the single color and the mixed color based on data obtained by actual measurement (a color measurement value).

For example, the client device 10 may display, on the result screen 130, a threshold value serving as an indicator for determining whether to perform a color adjustment for the single color and the mixed color. As the example illustrated in FIG. 12, a threshold value used for determining whether to perform a color adjustment for a single color (e.g., C, M, Y, and K) is set to be “3.0” and a threshold value used for determining whether to perform a color adjustment for a mixed color (e.g., gray) is set to be “1.5”. In other words, when “ΔEave” of the single color is “3.0” or less, the user can determine that it is not necessary to perform a color adjustment for the single color. When “ΔEave” of the mixed color is “1.5” or less, the user can determine that it is not necessary to perform a color adjustment for the mixed color. Note that “ΔEave” is a value determined in step S303 described above. In step S303, determining “ΔEave” for only a mixed color is described, however, this value can be determined also for a single color using the same Expressions 1 and 2.

Then, after termination of the confirmation processing S104, the client device 10 advances the process to step S105 as illustrated in FIG. 7 and determines whether or not an instruction for indicating OK (no color adjustment needs to be performed) with respect to the single color is issued (step S105). Specifically, the client device 10 functions as the color adjustment instructing unit 44 and determines whether or not the calibration execution button 121 on the result screen 130 is operated while the single color check box 122 is checked.

When the calibration execution button 121 is operated while the single color check box 122 is checked, the client device 10 determines that the result is not OK for the single color (a color adjustment needs to be performed again) (step S105: No) and returns the process to step S102. Thereby, until the result becomes OK for the single color, the single color adjustment processing S102 can be repeatedly executed.

On the other hand, when the calibration execution button 121 is not operated while the single color check box 122 is checked, the client device 10 determines that the result is OK for the single color (no color adjustment needs to be performed) (step S105: Yes) and advances the process to step S106.

Then, the client device 10 determines whether or not an instruction for indicating OK (no color adjustment needs to be performed) with respect to the mixed color is issued (step S106). Specifically, the client device 10 functions as the color adjustment instructing unit 44 and determines whether or not the calibration execution button 121 on the result screen 130 is operated while the mixed color check box 123 is checked.

When the calibration execution button 121 is not operated but the end button 125 or the like is operated, the client device 10 determines that the result is OK also for the mixed color (no color adjustment needs to be performed) (step S106: Yes) and then terminates this flowchart.

On the other hand, when the calibration execution button 121 is operated while the mixed color check box 123 is checked, the client device 10 determines that the result is not OK for the mixed color (a color adjustment needs to be performed) (step S106: No) and advances the process to the mixed color adjustment processing (step S107) illustrated in FIG. 13.

### <Mixed Color Adjustment Processing S107>

When the mixed color adjustment processing starts, the client device 10 transmits an instruction for outputting the mixed color chart 72 to the printer controller 20 (step S401). Specifically, the client device 10 functions as the driver unit 43, reads the mixed color chart 72 from the storage unit 45, and converts the chart into PDL data that can be interpreted by the printer controller 20. Then, the converted data is transmitted to the printer controller 20 as a print job.

At this time, when functioning as the receiving unit 51 to receive the print job transmitted from the client device 10, the printer controller 20 executes processing necessary to print the mixed color chart 72. Specifically, the printer controller 20 functions as the RIP processing unit 52 and executes RIP processing for the mixed color chart 72 included in the received print job to generate raster data in a bitmap format. As described above, the RIP processing includes the language analysis processing, the color conversion processing, the screen processing, and the like. In the color conversion processing in this case, a mixed color correction is performed by applying the latest single color correcting data and the mixed color correcting data stored in the storage unit 55.

After completion of the RIP processing, the printer controller 20 functions as the print instructing unit 54 and transmits raster data generated by the RIP processing to the printer 30. Then, when functioning as the receiving unit 61 to receive the raster data, the printer 30 controls, as the print control unit 62, the printing engine 35 and outputs the mixed color chart 72 as the example illustrated in FIG. 4 by printing the chart on one sheet.

Further, after transmitting an instruction for outputting the mixed color chart 72 in step S401, the client device 10 also transmits an instruction for measuring a color of the print result (printed matter) (step S402). Specifically, the client device 10 functions as the driver unit 43 and transmits, to the printer controller 20, data for issuing an instruction for color measurement.

At this time, when functioning as the receiving unit 51 to receive the instruction for color measurement from the client device 10, the printer controller 20 functions as the print instructing unit 54 and transmits, to the printer 30, a command for measuring a color of the print result (printed matter) of the mixed color chart 72. Then, when functioning as the receiving unit 61 to receive the command for the color measurement, the printer 30 controls, as the color measurement control unit 63, the color measurement device 37 and measures a color of the mixed color chart 72. After completion of the color measurement, the printer 30 transmits the color measurement result of the mixed color chart 72 to the printer controller 20.

When receiving the color measurement result of the mixed color chart 72, the printer controller 20 performs a color adjustment for the mixed color based on the received color measurement result (step S403). Specifically, the printer controller 20 functions as the color adjusting unit 53 and corrects the mixed color correcting data so that a color and a density upon printing each mixed color patch included in the mixed color chart 72 come closer to target values. Therefore, in step S403, the corrected mixed color correcting data updates the mixed color correcting data previously stored in the storage device 55. Hereinafter, the color adjustment preformed in step S403 is referred to as “mixed color calibration.”

When the mixed color calibration in S403 is terminated, the printer controller 20 terminates the mixed color adjustment processing S107.

When the mixed color adjustment processing S107 described above is performed by the color adjusting system 1, a color adjustment can be performed for a mixed color.

Then, when the mixed color adjustment processing S107 is terminated, the client device 10 terminates this flowchart as illustrated in FIG. 7.

The respective processing units in each flowchart described above are divided according to main processing contents in order to facilitate understanding the color adjusting system 1. The present invention is not limited by the classification manner or names of the processing steps. The processing executed in the color adjusting system 1 is dividable into a greater number of processing steps. Further, one processing step may include a greater number of processing steps.

As described above, in the present embodiment, the single color chart 71 to which the adjusted single color correcting data is applied and the mixed color chart 72 to which the adjusted single color correcting data and the mixed color correcting data are applied, are printed on one sheet, in step S301. Therefore, a user can determine whether to perform a color adjustment for a mixed color by referring to both the single color chart 71 and the mixed color chart 72. The reason is that even when single color chart 71 is printed appropriately, there is a problem in a color (gray) balance obtained by composing a plurality of single colors when the mixed color chart 72 is not printed appropriately.

In other words, at the time of step S301, a user can determine whether to perform a color adjustment for a mixed color. Therefore, when there is no need to perform a color adjustment for the mixed color, no mixed color chart 72 needs to be prepared thereafter. Accordingly, unnecessary printing or color adjustment is not performed, resulting in an efficient color adjustment.

### Modification Examples

Further, the abovementioned embodiment is intended to illustrate the gist of the present invention and therefore the present invention is not limited thereto. A variety of substitutes, corrections, and modification examples are apparent to those skilled in the art.

In the abovementioned embodiment, for example, the single color chart 71 and the mixed color chart 72 as illustrated in FIG. 5 are printed on one sheet. However, the present invention is not limited thereto. For example, the mixed color chart 72 may include, in addition to gray color patches, mixed color patches other than the gray color ones, that are obtained by composing at least two single colors at a predetermined ratio.

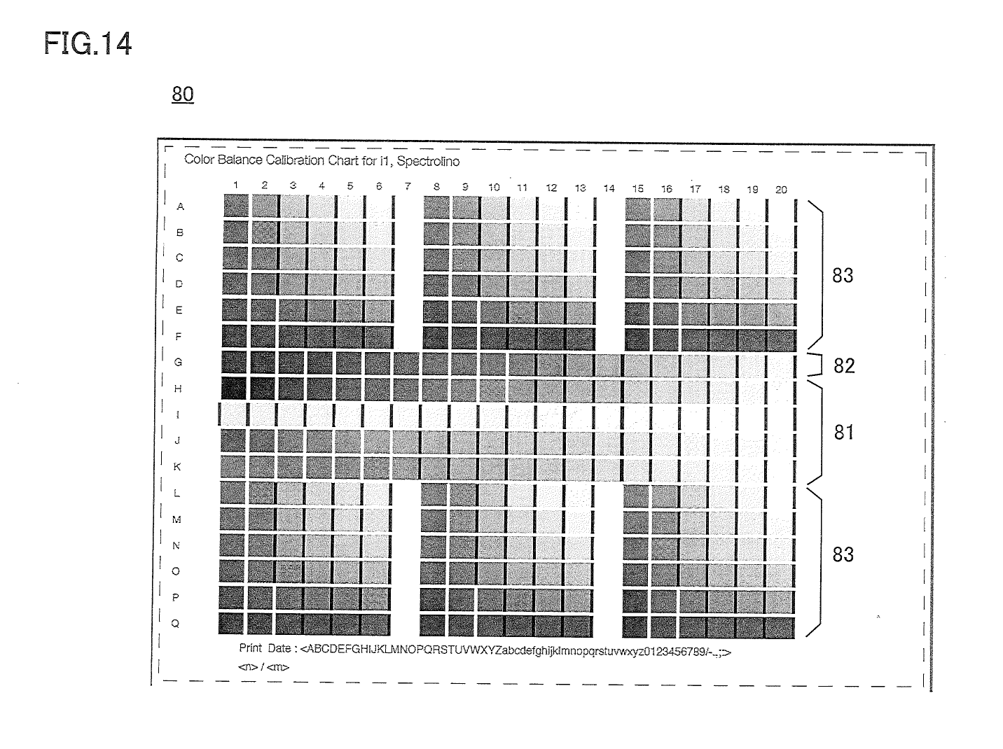

FIG. 14 is a view illustrating a modification example of a single color chart and a mixed color chart. In the example illustrated in FIG. 14, a single color chart 81 includes 20×4 single color patches with different densities arranged for each single color of cyan (C), magenta (M), yellow (Y), and black (K). Further, in the example illustrated in FIG. 14, a first mixed color chart 82 includes 20 mixed color patches with different densities arranged for gray color (for example, a color obtained by composing single colors of cyan (C), magenta (M), and yellow (Y) at a ratio of 1:1:1). In addition thereto, a second mixed color chart 83 may include 20×12 mixed color patches, excluding the gray color, that are obtained by composing at least two single colors at different ratios for each.

When the single color chart 81, the first mixed color chart 82, and the second mixed color chart 83 as described above are output on one sheet and then a color adjustment is performed, a more highly accurate color adjustment can be performed for a mixed color.

Further, it is possible to output (print) one type of chart by selecting from a plurality of types of charts previously prepared, as needed. For example, when a highly accurate color adjustment is necessary, it is possible to output a chart having the format illustrated in FIG. 14 and when a color adjustment is not necessary to such a highly accurate extent, it is possible to output a chart having the format illustrated in FIG. 5.

Further, in the abovementioned embodiment, insteps S201, S301, and S401, charts in separate formats are output respectively. However, the present invention is not limited thereto, and in any steps of S201, S301, and S401, charts in the same format, for example, charts including both the single color chart 71 and the mixed color chart 72 as illustrated in FIG. 5 may be output on one sheet.

Further, while no description has been made in the abovementioned embodiment, separate pieces of attribute information are allocated to the single color chart 71 and the mixed color chart 72, respectively. For example, the single color chart 71 is prepared as an image attribute object and the mixed color chart 72 is prepared as a graphics attribute object. Then, when performing a color conversion on the single color chart 71 and the mixed color chart 72, the printer controller 20 determines correcting data to be applied according to the allocated attribute information. For example, single color correcting data is applied to the single color chart 71 with the image attribute allocated, and both single color correcting data and mixed color correcting data are applied to the mixed color chart 72 with the graphics attribute allocated. Needless to say, types of the attribute information are not limited thereto and another attribute is employable.

Further, in steps S105 and S106 of the abovementioned embodiment, a user determines whether to perform a color adjustment in view of a print result and the like of the single color chart 71 and the mixed color chart 72. However, the present invention is not limited thereto. For example, it is possible for the client device 10 to determine, with no determination by a user, whether an adjustment result of a density of a single color (e.g., “ΔEave” for single color patches) is less than or equal to a predetermined threshold value and then decide whether to perform a color adjustment for the single color. Further, it is possible for the client device 10 to determine whether an adjustment accuracy of a mixed color (e.g., “ΔEave” for mixed color patches) is less than or equal to a predetermined threshold value and then decide whether to perform a color adjustment for the mixed color.

Further, in the color conversion processing of the abovementioned embodiment, a color conversion is performed within the same color space (e.g., C, M, Y, and K). However, in the color conversion processing of the present invention, the abovementioned method is not necessarily employed. For example, it is possible that an input color space (i.e., a device-dependent color space used for intermediate data) is temporarily converted into a device-independent color space such as Lab and then converted into an output color space supported in the printer 30.

Further, in the abovementioned embodiment, the color measurement device 37 is connected to the printer 30. However, the present invention is not limited thereto, and the color measurement device 37 may be connected to the client device 10 or the printer controller 20, or to the network 5. Further, while not specifically referred to in the abovementioned embodiment, the color measurement device 37 includes a function of converting a color measurement result into a device-independent color specification value such as Lab and XYZ.

Further, in the abovementioned embodiment and the abovementioned modification example, the client device 10, the printer controller 20, and the printer 30 are described as separate devices, but the present invention is not limited thereto. For example, at least a part of the processing executed by the client device 10 in the abovementioned embodiment and the abovementioned modification example may be executed by the printer controller 20 or the printer 30. Further, at least a part of the processing executed by the printer controller 20 in the abovementioned embodiment and the abovementioned modification example may be executed by the client device 10 or the printer 30. Further, at least a part of the processing (e.g., color measurement) executed by the printer 30 in the abovementioned embodiment and the abovementioned modification example may be executed by the client device 10 or the printer controller 20.

Further, in the abovementioned embodiment and the abovementioned modification example, the printing engine 35 employs an electrophotographic system, however, an inkjet system or a thermal transfer system is employable other than the electrophotographic system.

With respect to the configuration of the color adjusting system 1, a main configuration has been described to describe the characteristics of the abovementioned embodiment, but the present invention is not limited to the abovementioned configuration. A common configuration provided for the color adjusting system 1 is not excluded.

Further, each functional configuration of the color adjusting system 1 described above has been classified according to the main processing contents to facilitate understanding each functional configuration. The present invention is not limited by the classification manner and names of the components. Each functional configuration may also be classified into a greater number of components according to processing contents. Further, one component may be classified so as to execute a greater number of processing steps.

Further, a program causing the color adjusting system 1 to operate may be provided by a non-transitory computer readable recording medium such as a USB memory, a Floppy (registered trademark) disk, a CD-ROM, and the like, or online via a network such as the Internet. In this case, the program stored on a non-transitory computer readable recording medium is commonly transferred to a memory (12, 22, or 32), a storage (13, 23, or 33), or the like to be stored. Further, this program may be provided, for example, as a separate application software or incorporated, as one function of the color adjusting system 1, in a software of each device thereof.

Further, the processing of each functional configuration described above may also be realized using a dedicated hardware circuit. In this case, the processing may be executed by one hardware device or a plurality of hardware devices.

The entire disclosure of Japanese Patent Application No. 2013-118071 filed on Jun. 4, 2013 including specification, claims, drawings and summary are incorporated herein by reference in its entirety.

What is claimed is:

1. A color adjusting system for performing a color adjustment by printing a single color chart that expresses a single color used for an image forming material for printing, using a plurality of single color patches with different densities, and a mixed color chart that expresses a mixed color obtained by composing said plurality of different single colors at a predetermined ratio, using a plurality of mixed color patches with different densities, said system comprising:
a storage unit storing mixed color data for performing color and density adjustments for said mixed color;
a first printing unit printing said single color chart;
a single color data preparing unit preparing single color data for performing a density adjustment for said single color based on a color measurement result of said single color patches in said printed single color chart; and
a second printing unit printing said single color chart and said mixed color chart on one sheet by applying, to said single color chart, single color data prepared by said single color data preparing unit and by applying, to said mixed color chart, said single color data and said existing mixed color data.

2. The color adjusting system as claimed in claim 1 further comprising:
an accuracy calculating unit calculating an adjustment accuracy in color and density based on a color measurement result of said mixed color patches in said mixed color chart printed by said second printing unit; and
a display unit displaying said adjustment accuracy calculated by said accuracy calculating unit.

3. The color adjusting system as claimed in claim 2 further comprising:
a third printing unit printing said mixed color chart by applying said single color data prepared by said single color data preparing unit to said mixed color chart;
a mixed color data preparing unit preparing mixed color data for performing color and density adjustments for said mixed color based on a color measurement result of said mixed color patches in said mixed color chart printed by said third printing unit; and
an updating unit updating said mixed color data stored in said storage unit, using said mixed color data prepared by said mixed color data preparing unit.

4. The color adjusting system as claimed in claim 1, wherein
separate pieces of attribute information are allocated to said single color chart and said mixed color chart, and
said second printing unit determines whether to apply said single color data or both of said single color data and said mixed color data, according to said pieces of attribute information.

5. The color adjusting system as claimed in claim 1, wherein
said second printing unit prints one type of said single color chart and one type of said mixed color chart selected respectively from a plurality of types of said single color charts and a plurality of types of said mixed color charts, that are previously prepared, when printing said single color chart and said mixed color chart on one sheet.

6. A color adjusting method for performing a color adjustment by printing a single color chart that expresses a single color used for an image forming material for printing, using a plurality of single color patches with different densities, and a mixed color chart that expresses a mixed color obtained by composing said plurality of different single colors at a predetermined ratio, using a plurality of mixed color patches with different densities, said method comprising the steps of:
(a) printing said single color chart;
(b) preparing single color data for performing a density adjustment for said single color based on a color measurement result of said single color patches in said printed single color chart; and
(c) printing said single color chart and said mixed color chart on one sheet by applying, to said single color chart, single color data prepared in said step (b) and by applying, to said mixed color chart, said single color data and existing mixed color data for performing color and density adjustments for said mixed color.

7. The color adjusting method as claimed in claim 6 further comprising the steps of:
(d) calculating an adjustment accuracy in color and density based on a color measurement result of said mixed color patches in said mixed color chart printed in said step (c); and
(e) displaying said adjustment accuracy calculated in said step (d).

8. The color adjusting method as claimed in claim 7 further comprising the steps of:
(f) printing said mixed color chart by applying, to said mixed color chart, said single color data prepared in said step (b);
(g) preparing mixed color data for performing color and density adjustments for said mixed color based on a color measurement result of said mixed color patches in said mixed color chart printed in said step (f); and
(h) updating said existing mixed color data using mixed color data prepared in said step (g).

9. The color adjusting method as claimed in claim 6, wherein
separate pieces of attribute information are allocated to said single color chart and said mixed color chart, and
said step (c) determines whether to apply said single color data or both of said single color data and said mixed color data, according to said pieces of attribute information.

10. The color adjusting method as claimed in claim 6, wherein
said step (c) prints one type of said single color chart and one type of said mixed color chart selected respectively from a plurality of types of said single color charts and a plurality of types of said mixed color charts, that are previously prepared, when printing said single color chart and said mixed color chart on one sheet.

11. A non-transitory computer readable recording medium stored with a color adjusting program, said color adjusting program being a color adjusting program causing a computer to perform a color adjustment by printing a single color chart that expresses a single color used for an image forming material for printing, using a plurality of single color patches with different densities, and a mixed color chart that expresses a mixed color obtained by composing said plurality of different single colors at a predetermined ratio, using a plurality of mixed color patches with different densities, said program causing a computer to execute a process comprising the steps of:
(a) printing said single color chart;
(b) preparing single color data for performing a density adjustment for said single color based on a color measurement result of said single color patches in said printed single color chart; and
(c) printing said single color chart and said mixed color chart on one sheet by applying, to said single color chart, single color data prepared in said step (b) and by applying, to said mixed color chart, said single color data and existing mixed color data for performing color and density adjustments for said mixed color.

12. The non-transitory computer readable recording medium as claimed in claim 11 further causing a computer to execute a process comprising the steps of:
(d) calculating an adjustment accuracy in color and density based on a color measurement result of said mixed color patches in said mixed color chart printed in said step (c); and
(e) displaying said adjustment accuracy calculated in said step (d).

13. The non-transitory computer readable recording medium as claimed in claim 12 further causing a computer to execute a process comprising the steps of:
(f) printing said mixed color chart by applying, to said mixed color chart, said single color data prepared in said step (b);
(g) preparing mixed color data for performing color and density adjustments for said mixed color based on a color measurement result of said mixed color patches in said mixed color chart printed in said step (f); and
(h) updating said existing mixed color data using mixed color data prepared in said step (g).

14. The non-transitory computer readable recording medium as claimed in claim 11, wherein
separate pieces of attribute information are allocated to said single color chart and said mixed color chart, and
said step (c) determines whether to apply said single color data or both of said single color data and said mixed color data, according to said pieces of attribute information.

15. The non-transitory computer readable recording medium as claimed in claim 11, wherein
said step (c) prints one type of said single color chart and one type of said mixed color chart respectively selected from a plurality of types of said single color charts and a plurality of types of said mixed color charts, that are previously prepared, when printing said single color chart and said mixed color chart on one sheet.
